(19) United States
(12) Patent Application Publication
(10) Pub. No.: US 2009/0077059 A1
(43) Pub. Date: Mar. 19, 2009

(54) METHOD AND APPARATUS FOR LINKAGE OF QUANTITATIVE AND QUALITATIVE TEXTUAL, AUDIO, VISUAL AND OTHER INFORMATION SEARCHES TO METRIC DISPLAYS

(76) Inventors: Robert J. Torres, Colleyville, TX (US); James R. Rudd, Charlotte, NC (US)

Correspondence Address: IBM CORP (YA);C/O YEE & ASSOCIATES PC, P.O. BOX 802333, DALLAS, TX, 75380, US

(21) Appl. No.: 11/857,577

(22) Filed: Sep. 19, 2007

(51) Int. Cl. G06F 17/30

(52) U.S. Cl. 707/5; 707/E17.008

(57) ABSTRACT

The improved metric display displays links to qualitative information, and indicates if the qualitative information may affect the current or future value of a quantitative metric. The improved metric display displays a quantitative metric, one or more links to ranked qualitative information related to the metric by key words or phrases, and an indicator of the qualitative information's potential effect on the current or future value of the quantitative metric.

### FIELD OF THE INVENTION

The invention relates generally to computer data processing, and particularly to an improved metric display having links to qualitative information.

### BACKGROUND OF THE INVENTION

Internet users commonly access information in two distinct ways. One way accesses continuously updated quantitative information in metric displays. The second way accesses displayed quantitative and qualitative information related to key words or phrases using search engines.

Metrics of various types are displayed in dashboards and scoreboards, but can be displayed in any visual or other form of presentation including tabular, chart, graphics, and sound presentation. These metric displays are miniature web browser windows that display a set of constantly updated quantitative information. A common example is a window displaying a constantly updated stock ticker or sports score. The metric display may include one or more links to windows with related information.

Search engines, also known as web crawlers, search the entire web or a subset of the web to produce a ranked list of ‘hits.’ For example, a subset of the web can be anew information service. These hits can be easily customized based on qualitative information provided by key words or phrases. For example, http://news.google.com has an option to customize the page where the user can define keywords, and the web page will rank news stories containing the desired key words higher than those that do not contain the key words.

Current metric displays rely on updates to quantitative inputs that come only from the program providing the metrics, and there is no linkage between qualitative or quantitative information from non-programmatic sources such as news stories. In other words, there is no link showing the potential effect on a quantitative metric from the results of a qualitative event.

But a user viewing a metric must also be sensitive to how the figures displayed are influenced by potential or actual events and that the metric value will change eventually based on those events. For example, a metric that is influenced by the price of oil or a labor strike will be affected by news related to those two areas. Therefore, a need exists to integrate the capabilities of search engines with metric reporting capabilities.

### SUMMARY OF THE INVENTION

The improved metric display links to qualitative information, and indicates if the qualitative information may affect the current or future value of a quantitative metric. The improved metric display has a quantitative metric, one or more links to ranked qualitative information related to the metric by key words or phrases, and an indicator of the qualitative information's potential effect on the current or future value of the quantitative metric.

### BRIEF DESCRIPTION OF DRAWINGS

FIG. 1 depicts an exemplary computer network;

FIG. 2 depicts an exemplary memory containing components of the enhanced metric display;

FIG. 3 depicts a flowchart of the set up component;

FIG. 4 depicts a flowchart of the analysis component;

FIG. 5 depicts a flowchart of the display component;

FIG. 6 depicts an exemplary display of the enhanced metric display; and

FIG. 7 depicts an exemplary drilldown display.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “enhanced metric display.”

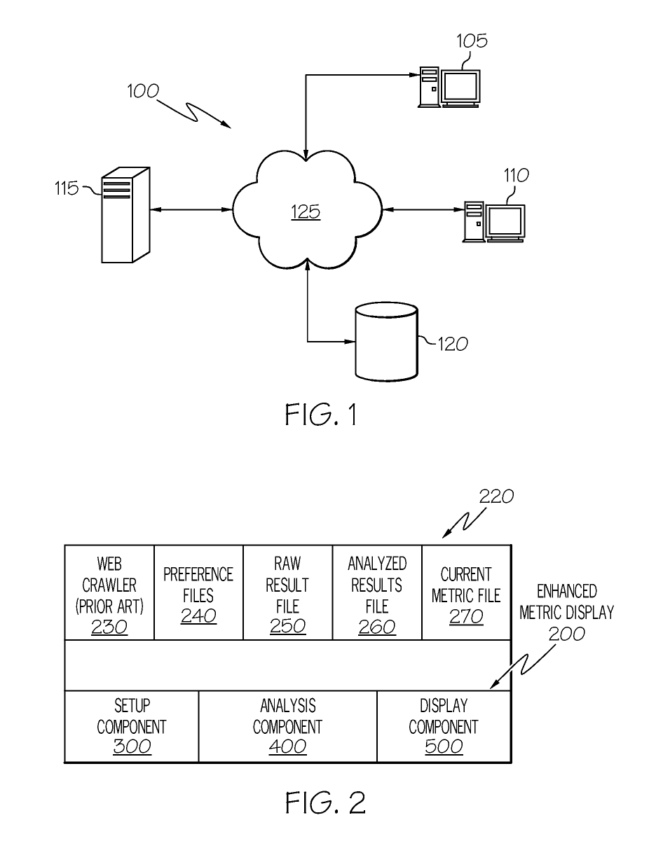

Additionally, the enhanced metric display is described below with reference to an exemplary network of hardware devices, as depicted in FIG. 1. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including workstation computer 105, workstation computer 110, server computer 115, and persistent storage 120. Network connection 125 comprises all hardware, software, and communications media necessary to enable communication between network nodes 105-120. Unless otherwise indicated in context below, all network nodes use publicly available protocols or messaging services to communicate with each other through network connection 125.

Enhanced metric display 200 typically is stored in a memory, represented schematically as memory 220 in FIG. 2. The term “memory” as used herein, includes without limitation any volatile or persistent medium, such as an electrical circuit, magnetic disk, or optical disk, in which a computer can store data or software for any duration. As shown in FIG. 2, memory 220 contains enhanced metric display 200 comprising setup component 300, analysis component 400, and display component 500. Memory 220 also contains web crawler 230, preference file 240, raw results file 250, analyzed results file 260, and current metric file 270 with which enhanced metric display 200 interacts.

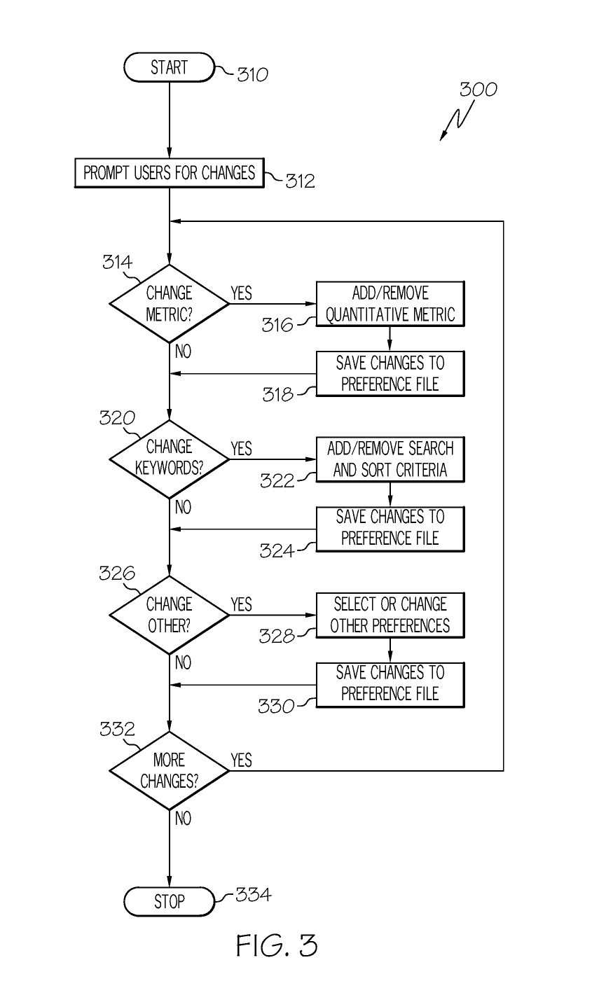

FIG. 3 depicts the logic of setup component 300. Setup component 300 starts (310) and prompts the user for changes (312). If the user desires to change a metric (314), then the user adds or removes a quantitative metric (316) and saves changes to preference file 240 (318). For example, the user could change a metric by setting the quantitative display metric to be a stock ticker, a commodity price, a federal deficit, a sports score, an election poll result or some other quantitative result.

If the user desires to change keywords (320), the user adds or removes search and sort criteria (322) and saves the changes to preference file 240 (324). For example, the user may set qualitative keywords related to the selected metric and the ranking logic for the web crawler which searches based on criteria set in preference file 240. Search criteria includes such things as key words and preferred new sources. If the user desires to make other changes (326), the user selects or enters the changes (328) and saves the changes to preference file 240 (330). Examples of other changes the user may make are to set user preferences such as a number of news item hits to display, a refresh rate, whether to allow automatic keyword or metric updates based on browser history, how current news items must be for inclusion, preferred news sources, and so forth. If at step 314, 320 or 326, the user does not desire to make a change, the process continues to the next choice. If at step 332, the user does not desire to make additional changes, setup component 300 ends (334).

Persons skilled in the art will recognize that user input can be entered manually, user input can be can chosen from a list, and user input can be automatically generated based on web browser history. Additionally, one or more of the three foregoing methods can be combined. For example, if the ranked news story includes a combination of the terms “increased, dropped, and/or price” a current effect flag will be marked. If the news story contains a combination of the terms “expect, predict, increase, and/or price” then the future effect flag will be marked. The difference between whether a story affects the current price or future prices may often be a matter of verb tense.

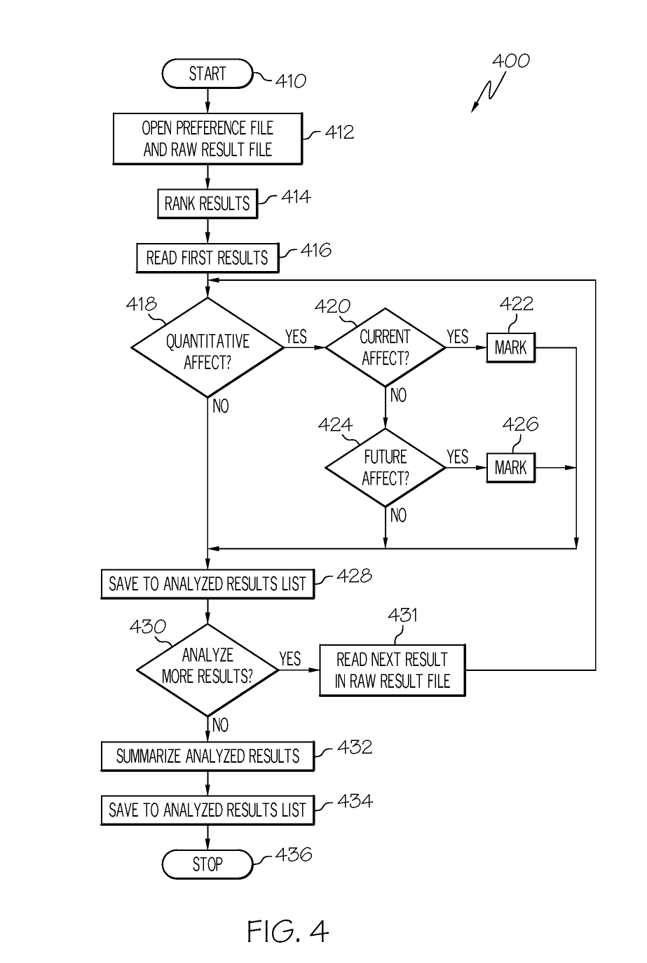

FIG. 4 is a flowchart of analysis component 400. Analysis component 400 starts (410) and opens preference file 240 and raw results file 250. Analysis component 400 then ranks the results from raw results file 250 in accordance with applicable preferences from preference file 240 (414), and reads the first result (416). Analysis component 400 determines whether the result has a quantitative effect on the metric (418). If so, analysis component 400 determines whether the effect is current (420) or future (424). If the effect is current, the current effect is marked (422). If the effect is future, the future effect is marked (426). The result is then saved to the analyzed result list (428). Next, analysis component 400 determines whether there are more results to be analyzed (430). If so, the next result is read from raw results file 250 (431). If there are no more results to be analyzed (430), the results are summarized (432), saved to the analyzed results list (434), and analysis component 400 stops (436).

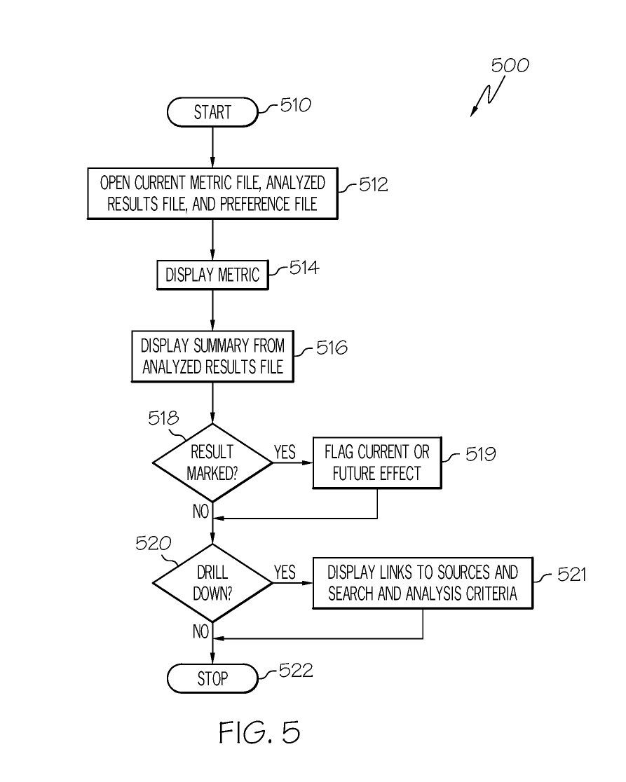

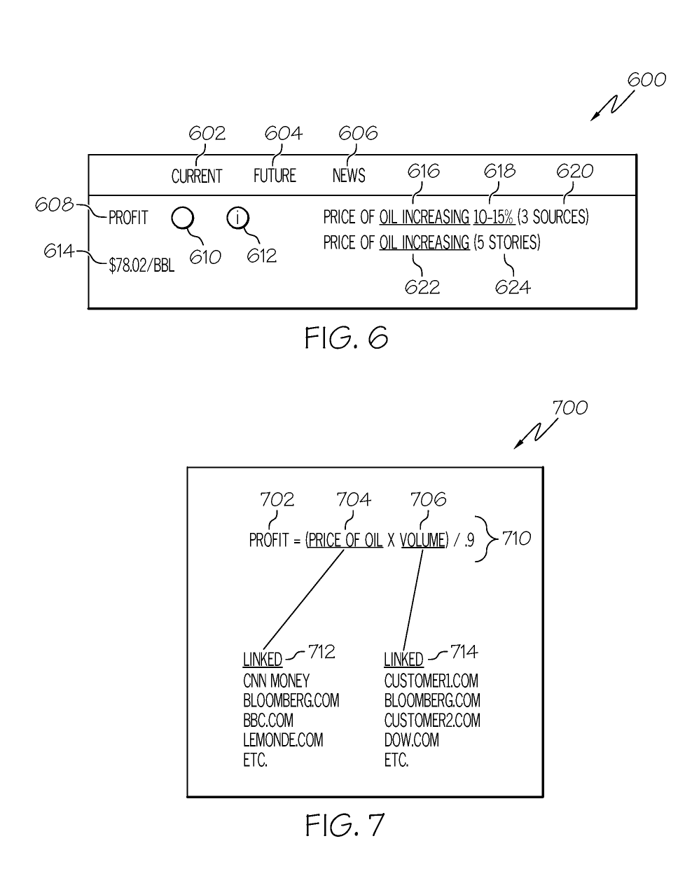

FIG. 5 is a flowchart of display component 500. Display component 500 starts (510) by opening current metric file 270, analyzed results file 260, and preference file 240 (512). Display component 500 displays the metric (514) and also displays the display summary from analyzed results file 260 (516). If a result is marked (518), then the metric is flagged to indicate a current or future effect (519). If the user selected drill down as an option (by activating control “i” 612 shown in the example of FIG. 6) (520), display component 500 displays links to sources and search and analysis criteria (as shown in the example of FIG. 7) (521). Display component stops (522).

FIG. 6 depicts improved exemplary metric display 600. By activating control “i” 612 on exemplary metric display 600, the user receives links such as first link 616 to five stories (see 624) about the price of oil increasing (622), or more specific links about the price of oil increasing (616) 10-15% (618). Exemplary metric display 600 shows current oil price per barrel (614). By activating profit button 610 the user receives a second display as shown in FIG. 7. Profit is defined by formula 710 comprising the terms profit 702, price of oil 704 and volume 706. In the example of FIG. 7 the words “price of oil” are linked to four or more web pages 712 with related information. The word “volume” is linked to four or more web pages 714 that provide qualitative and quantitative information regarding oil volume. The related web sites provide a better understanding of the content and algorithms that are causing the links to be displayed (or alternatively alert messages to be displayed). In other words, the user can see how the algorithm is defined as well as the actual content sources that are being used in the algorithm. The weighting of the content source is also conveyed in this window. For example, if the metric “cost” is linked to the price of oil or electricity, then any new stories related to electricity will be flagged and indicated to a user. If a measurable data element can be extracted, then a predicted impact is generated and provided. For example, if oil is predicted to increase by 10%, the impact to the metric is computed and displayed.

Persons skilled in the art will realize that the improved metric display can be further extended to extract qualitative information to apply algorithms to display the extracted qualitative information in the end user's metric display. Moreover, both quantitative as well as qualitative information can be searched. For example, the numeric 10%, the written “ten percent,” and the audible “ten percent” (recorded speech or digitally created speech) are all accessible for search.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A computer implemented process for displaying a metric in an enhanced metric display, the computer implemented process comprising:
opening a preference file and a raw results file;
using a search engine, analyzing a plurality of sources to identify a plurality of results;
saving the plurality of results to the raw results file;
ranking the plurality of results from the raw results file in accordance with a plurality of applicable preferences from the preference file;
reading a first result;
saving the first result to an analyzed result list;
displaying the metric and a summary from the analyzed results file.

2. The computer implemented process of claim 1 further comprising:
when the first result has a quantitative effect on the metric, determining whether the quantitative effect is a current effect or a future effect.

3. The computer implemented process of claim 2 further comprising:
when the quantitative effect is a future effect, saving the result to the analyzed result list.

4. The computer implemented process of claim 1 further comprising:
when there are no more results to be analyzed, summarizing the results and saving the summary to the analyzed results list.

5. The computer implemented process of claim 1 further comprising:
opening a current metric file, analyzed results file, and preference file.

6. The computer implemented process of claim 2 further comprising:
displaying a result marked as a current effect.

7. The computer implemented process of claim 2 further comprising:
displaying a result marked as a future effect.

8. The computer implemented process of claim 1 further comprising:
when a user selects a drill down option, displaying a link to a source and a search and analysis criteria.

9. An enhanced metric display comprising:
a computer connected to a network and having a memory;
a display connected to the computer;
a program in the memory containing instructions to cause the computer to perform the following steps:
opening a preference file and a raw results file;
searching for a plurality of results over the network;
ranking a plurality of results from the raw results file in accordance with a plurality of applicable preferences from the preference file;
reading a first result;
saving the first result to an analyzed result list;
displaying a metric and a summary from the analyzed results file.

10. The apparatus of claim 9 wherein the instructions further comprise:
when the first result has a quantitative effect on the metric, determining whether the quantitative effect is a current effect.

11. The apparatus of claim 9 wherein the instructions further comprise:
when the first result has a quantitative effect on the metric, determining whether the quantitative effect is a future effect.

12. The apparatus of claim 9 wherein the instructions further comprise:
when there are no more results to be analyzed, summarizing the results and saving the summary to the analyzed results list.

13. The apparatus of claim 9 wherein the instructions further comprise:
opening a current metric file, an analyzed results file, and a preference file.

14. The apparatus of claim 11 wherein the instructions further comprise:
displaying a result marked as a current effect.

15. The apparatus of claim 11 wherein the instructions further comprise:
displaying a result marked as a future effect.

16. The apparatus of claim 9 wherein the instructions further comprise:
when the user selects drill down as an option, displaying a link to a source and a search and analysis criteria.

17. A computer readable memory containing a plurality of instructions encoded thereon to cause a computer to display an enhanced metric, the plurality of instructions comprising:
opening a preference file and a raw results file;
using a network, searching a plurality of sources for a plurality of results;
ranking the plurality of results from the raw results file in accordance with a plurality of applicable preferences from the preference file;
reading a first result;
when the first result has a quantitative effect on the metric, determining whether the quantitative effect is a current effect or a future effect;
saving the first result to an analyzed result list; and
displaying the metric and the summary from the analyzed results file.

18. The computer readable memory of claim 17 wherein the plurality of instructions further comprises:
when the user selects drill down as an option, displaying a link to a source and a search and analysis criteria.

19. The computer readable memory of claim 17 wherein the plurality of instructions further comprises:
when there are no more results to be analyzed, summarizing the results and saving the summary to the analyzed results list.

20. The computer readable memory of claim 13 wherein the plurality of instructions further comprises:
opening a current metric file, analyzed results file, and preference file.
